(19) United States
(12) Patent Application Publication
(10) Pub. No.: US 2016/0360220 A1
(43) Pub. Date: Dec. 8, 2016

(54) SELECTIVE PACKET AND DATA DROPPING TO REDUCE DELAY IN REAL-TIME VIDEO COMMUNICATION

(71) Applicant: Apple Inc., Cupertino, CA (US)

(72) Inventors: Peikang Song, San Jose, CA (US); Jae Hoon Kim, San Jose, CA (US); Xiaosong Zhou, Campbell, CA (US); Chris Y. Chung, Sunnyvale, CA (US); Hsi-Jung Wu, San Jose, CA (US); Dazhong Zhang, Milpitas, CA (US)

(21) Appl. No.: 14/730,830

(22) Filed: Jun. 4, 2015

(51) Int. Cl. H04N 19/51; H04N 19/172; H04N 19/159; H04N 19/139; H04N 19/142

(52) U.S. Cl. CPC H04N 19/51; H04N 19/139; H04N 19/142; H04N 19/159; H04N 19/172

(57) ABSTRACT

Techniques are described for responding to changes in bandwidth that are available to transmit coded video data between an encoder and a decoder. When such changes in bandwidth occur, estimates may be derived of visual significance of coded video data that has not yet been transmitted and also video data that is next to be coded. These estimates may be compared to each other. When the estimated visual significance of the coded video data that has not yet been transmitted is greater than the estimated visual significance of the video data that is next to be coded, transmission of the coded video data that has not yet been transmitted may be prioritized over coding of the video data that is next to be coded. When the estimated visual significance of the video data that is next to be coded is greater than the estimated visual significance of the coded video data that has not yet been transmitted, coding of the video data that is next to be coded may be prioritized over transmission of the coded video data that has not yet been transmitted. Resources may be allocated to the prioritized coder operation.

### BACKGROUND

The present disclosure relates to video coding systems and, in particular, to techniques for managing such systems in the face of fluctuating bandwidth.

Many modern electronic devices support exchange of video between them. In many applications, a first device captures video locally by an electronic camera and processes the captured video for transmission to another device via a bandwidth-limited channel. The video typically has a predetermined frame size and frame rate that does not change during the video exchange process. Several coding protocols have been defined to support video compression and decompression operations. They include, for example, the ITU H.263, H.264 and H.265 standards.

Oftentimes, video coding systems estimate the level of bandwidth that is available to carry coded video between the devices, then select coding parameters according to the estimated bandwidth. For example, a video coder may define a target bit rate for coded video, then attempt to ensure that the coded video it generates on average meets the target bit rate. One coded video frame may have a very different bit size than other coded frames from the same video sequence, however, owing to a coding mode that is applied to the frame (e.g., intra-coding vs. inter-coding vs. SKIP coding) and to other coding parameters that are applied. Thus, the sizes of coded frames likely will not be uniform with a stream of coded video. Moreover, the bit rates of coded frames can vary unpredictably in response to changing coding parameters, particularly quantization parameters, which makes it difficult for video coders to predict the sizes of coded video frames before coding is performed. Thus, selection of coding parameters also may vary during coding, even if a target bit rate estimate does not change.

Real-time video applications may suffer from sudden network bandwidth losses, which can create transmission problems. If bandwidth levels drop quickly, then frames that are coded according to stale bandwidth estimates may take longer to be transmitted to a receiving device, which can lead to visual artifacts on decode such as “frozen” video playback. Such problems can be exacerbated with some network protocols that require transmissions to be acknowledged and retransmission, if necessary.

The inventors perceive a need for a video coding system that can respond to sudden changes in network bandwidth and avoid artifacts that otherwise may arise in video playback.

### BRIEF DESCRIPTION OF THE DRAWINGS

FIG. 1 is a simplified block diagram of an encoder/decoder system according to an embodiment of the present disclosure.

FIG. 2 is a functional block diagram of terminals that perform video coding and decoding according to an embodiment of the present disclosure.

FIG. 3 illustrates a method according to an embodiment of the present disclosure.

FIGS. 4(a) and 4(b) illustrate an exemplary video sequence upon which the method may operate.

### DETAILED DESCRIPTION

Embodiments of the present disclosure provide techniques for responding to changes in bandwidth that are available to transmit coded video data between an encoder and a decoder. When such changes in bandwidth occur, estimates may be derived of visual significance of coded video data that has not yet been transmitted and also video data that is next to be coded. These estimates may be compared to each other. When the estimated visual significance of the coded video data that has not yet been transmitted is greater than the estimated visual significance of the video data that is next to be coded, transmission of the coded video data that has not yet been transmitted may be prioritized over coding of the video data that is next to be coded. When the estimated visual significance of the video data that is next to be coded is greater than the estimated visual significance of the coded video data that has not yet been transmitted, coding of the video data that is next to be coded may be prioritized over transmission of the coded video data that has not yet been transmitted. Resources may be allocated to the prioritized coder operation.

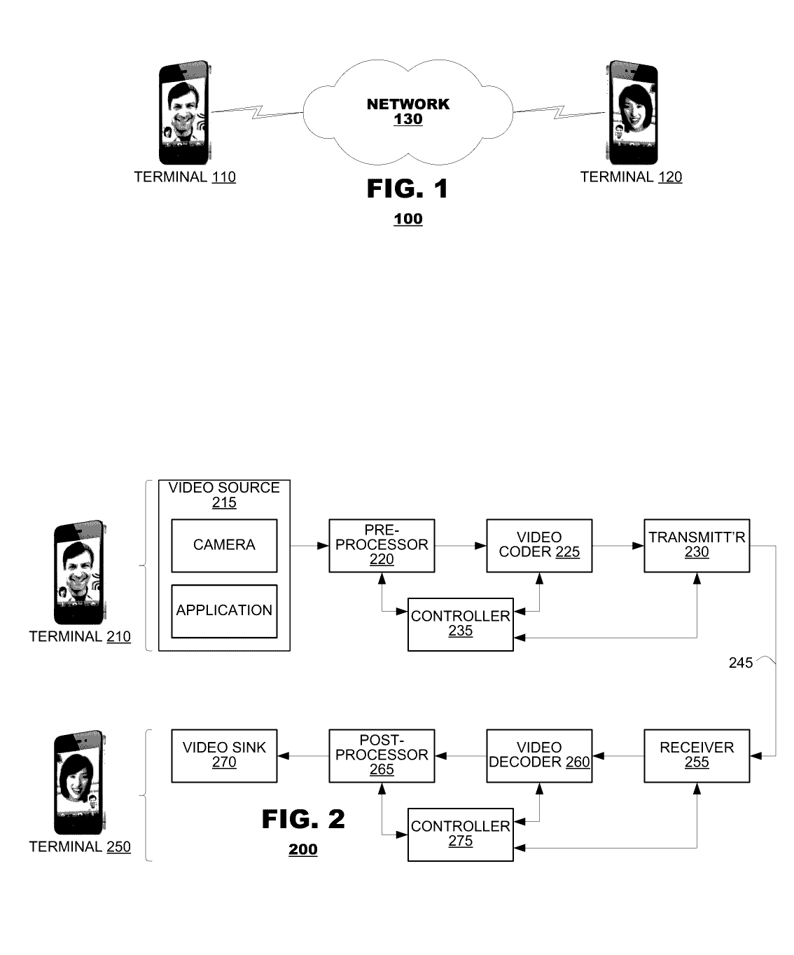

FIG. 1 is a simplified block diagram of an encoder/decoder system 100 according to an embodiment of the present disclosure. The system 100 may include first and second terminals 110, 120 interconnected by a network 130. The terminals 110, 120 may exchange coded video data with each other via the network 130, either in a unidirectional or bidirectional exchange. For unidirectional exchange, a first terminal 110 may capture video data from a local environment, code it and transmit the coded video data to a second terminal 120. The second terminal 120 may decode the coded video data that it receives from the first terminal 110 and may display the decoded video at a local display. For bidirectional exchange, both terminals 110, 120 may capture video data locally, code it and transmit the coded video data to the other terminal. Each terminal 110, 120 also may decode the coded video data that it receives from the other terminal and display it for local viewing.

Although the terminals 110, 120 are illustrated as smartphones in FIG. 1, they may be provided as a variety of computing platforms, including servers, personal computers, laptop computers, tablet computers, media players and/or dedicated video conferencing equipment.

The network 130 represents any number of networks that convey coded video data among the terminals 110, 120, including, for example, wireline and/or wireless communication networks. A communication network 130 may exchange data in circuit-switched and/or packet-switched channels. Representative networks include telecommunications networks, local area networks, wide area networks and/or the Internet. In many applications, however, the network 130 does not provide fixed bandwidth for communication between the terminals 110, 120. Indeed, bandwidth between the terminals 110, 120 may fluctuate rapidly and without notice provided to the terminals 110, 120. Moreover, bandwidth between the terminals 110, 120 may not be symmetric; the network 130 may provide a greater amount of bandwidth for transmission of video from the terminal 110 to the terminal 120 than it would for transmission of video from the terminal 120 to the terminal 110. For the purposes of the present discussion, the architecture and topology of the network 130 are immaterial to the present disclosure unless discussed hereinbelow.

FIG. 2 is a functional block diagram of terminals 210, 250 that perform video coding and decoding according to an embodiment of the present disclosure. A first terminal 210 may include a video source 215, a preprocessor 220, a video coder 225, a transmitter 230 and a controller 235. The video source 215 may generate a video sequence for coding. The preprocessor 220 may perform various processing operations that condition the input signal for coding. The coding engine 225 may perform data compression operations to reduce the bitrate of the video sequence output from the preprocessor 220. The transmitter 230 may transmit coded video data to another terminal 250 via a channel 245 provided by a network. The controller 235 may coordinate operation of the terminal 210 as it performs these functions.

Typical video sources 215 include image capture systems, such as cameras, that generate video from locally-captured image information. They also may include applications that execute on the terminal 210 and generate image information to be exchanged with a far-end terminal 250. Alternatively, the video source 215 may include storage devices (not shown) in which video may be stored, e.g., the video was generated at some time prior to the onset of a coding session. Thus, source video sequences may represent naturally-occurring image content or synthetically-generated image content (e.g., computer generated video), as application needs warrant. The video source also may provide the source video to other components within the terminal 210 such as a display (path not shown).

As indicated, the preprocessor 220 may perform video processing operations upon the camera video data to improve quality of the video data or to condition the video data for coding. The preprocessor 220 also may perform analytical operations on the video that it receives from the video source 215 to determine, for example, a size of the video, frame rate of the data, rates of change of content within the video, and the like. The preprocessor may alter these characteristics, particularly frame rate and/or frame size, as may be needed for the terminal 210 to meet target bit rates for the coded video. Optionally, the preprocessor 220 may perform other processes to improve quality of the video data such as motion stabilization and/or filtering. Filtering operations may include spatial filtering, temporal filtering, and/or noise detection and removal.

The coding engine 225 may code frames of video data to reduce bandwidth of the source video and meet the target bitrate. In an embodiment, the coding engine 225 may perform content prediction and coding.

Prediction and coding operations may reduce the bandwidth of the video sequence by exploiting redundancies in the source video's content. For example, coding may use content of one or more previously-coded “reference frames” to predict content for a new frame to be coded. Such coding may identify the reference frame(s) as a source of prediction in the coded video data and may provide supplementary “residual” data to improve image quality obtained by the prediction. Coding may operate according to any of a number of different coding protocols, including, for example, MPEG-4, H.263, H.264 and/or H.265. Such coding operations typically involve executing a transform on pixel data to another data domain as by a discrete cosine transform or a wavelet transform, for example. Transform coefficients further may be quantized by a variable quantization parameter and entropy coding. Each protocol defines its own basis for parsing input data into pixel blocks prior to prediction and coding. The principles of the present disclosure may be used cooperatively with these approaches.

The coding operations may include a local decoding of coded reference frame data (not shown). Many predictive coding operations are lossy operations, which causes decoded video data to vary from the source video data in some manner. By decoding the coded reference frames, the terminal 210 stores a copy of the reference frames as they will be recovered by the second terminal 250.

In embodiments involving scalable coding, the coding engine may generate and then code a base layer stream and one or more enhancement layer streams that represent the source video. Such preprocessing operations may vary dynamically according to operating states of the terminal 210, operating states of the network 130 (FIG. 1) and/or operating states of a second terminal 250 that receives coded video from the first terminal 210.

The transmitter 230 may format the coded video data for transmission to another terminal. Again, the coding protocols typically define a syntax for exchange of video data among the different terminals. Additionally, the transmitter 230 may package the coded video data into packets or other data constructs as may be required by the network. Once the transmitter 230 packages the coded video data appropriately, it may release the coded video data to the network 130 (FIG. 1).

The transmitter 230 may estimate periodically an amount of bandwidth that is available within the network 130 (FIG. 1) for transmission of coded video to the other terminal 250. The transmitter 230 may estimate this bandwidth level, for example, from indications of bit error rate and negative acknowledgements that it receives from the network 130 (FIG. 1) or from the other terminal 250.

FIG. 2 also illustrates functional units of a second terminal 250 that decodes coded video data according to an embodiment of the present disclosure. The terminal 250 may include a receiver 255, a decoding engine 260, a post-processor 265, a video sink 270 and a controller 275. The receiver 255 may receive coded video data from the channel 245 and provide it to the decoding engine 260. The decoding engine 260 may invert coding operations applied by the first terminal's coding engine 225 and may generate recovered video data therefrom. The post-processor 265 may perform signal conditioning operations on the recovered video data from the decoding engine 260, including dynamic range mapping as discussed below. The video sink 270 may render the recovered video data. The controller 275 may manage operations of the terminal 250.

As indicated, the receiver 255 may receive coded video data from a channel 245. The coded video data may be included with channel data representing other content, such as coded audio data and other metadata. The receiver 255 may parse the channel data into its constituent data streams and may pass the data streams to respective decoders (not shown), including the decoding engine 260. The receiver 255 may identify transmission errors in the coded video data that it receives from the channel 245 and, in response, may send error notification messages to the transmitter 230 via a return path in the channel 245.

The decoding engine 260 may generate recovered video data from the coded video data. The decoding engine 260 may perform prediction and decoding processes. For example, such processes may include entropy decoding, re-quantization and inverse transform operations that may have been applied by the coding engine 225. The decoding engine 260 may build a reference picture cache to store recovered video data of the reference frames. Prediction processes may retrieve data from the reference picture cache to use for predictive decoding operations for later-received coded frames. The coded video data may include motion vectors or other identifiers that identify locations within previously-stored reference frames that are prediction references for subsequently-received coded video data. Decoding operations may operate according to the coding protocol applied by the coding engine 225 and may comply with MPEG-4, H.263, H.264 and/or HEVC.

The post-processor 265 may condition recovered frame data for rendering. As part of its operation, the post-processor 265 may perform dynamic range mapping as discussed hereinbelow. Optionally, the post-processor 265 may perform other filtering operations to improve image quality of the recovered video data.

The video sink 270 represents units within the second terminal 250 that may consume recovered video data. In an embodiment, the video sink 270 may be a display device. In other embodiments, however, the video sink 270 may be provided by applications that execute on the second terminal 250 that consume video data. Such applications may include, for example, video games and video authoring applications (e.g., editors).

FIG. 2 illustrates functional units that may be provided to support unidirectional transmission of video from a first terminal 210 to a second terminal 250. In many video coding applications, bidirectional transmission of video may be warranted. The principles of the present disclosure may accommodate such applications by replicating the functional units 215-235 within the second terminal 250 and replicating the functional units 255-275 within the first terminal 210. Such functional units are not illustrated in FIG. 2 for convenience.

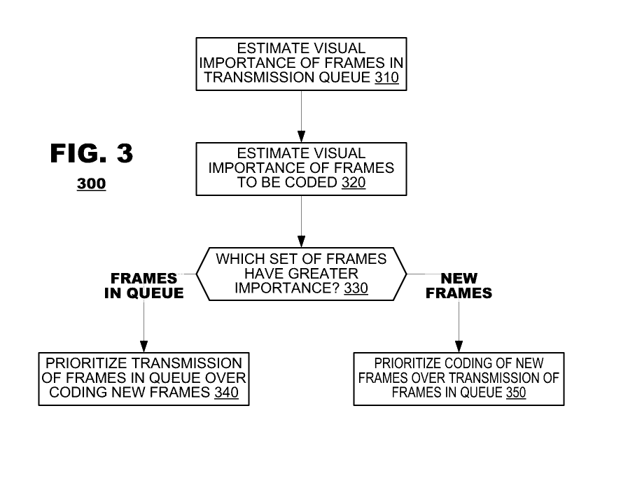

FIG. 3 illustrates a method 300 according to an embodiment of the present disclosure.

The method 300 may be invoked when a bandwidth change is detected at an encoder and, in particular, a bandwidth change that reduces a data rate that is available to support a video coding session. In response to the bandwidth change, the method 300 may estimate a visual importance of coded frames in queue at a transmitter (box 310) and also may estimate a visual importance of frames that await coding by a video coder (box 320). The method 300 may determine which set of frames has greater importance based on visual importance of content and corresponding latency (box 330). If the frames in queue are estimated to have greater importance than the frames awaiting coding, the method 300 may prioritize transmission of the frames in queue and reduce resources afforded to coding of the new frames (box 340). If the frames awaiting coding are estimated to have greater importance than the frames in queue, the method 300 may prioritize coding of the new frames and reduce resources provided to transmission of frames in queue (box 350).

Estimation of visual importance of frames may occur in a variety of ways. For example:
Scene Changes: Frames that precede a scene change in display order may be assigned relatively lower visual importance than frames that follow a scene change in display order. Because a scene change effectively replaces scene content of prior frames, those prior frames even if preserved during a bandwidth change likely will have less significance than frames the follow the scene change.
Object Detection: Frames that are identified as having objects of designated types may be assigned relatively higher visual importance than frames that do not have such objects. Object detection may be performed to recognize human faces, for example.
Content Activity: Frames that are identified as having relatively high motion may be assigned relatively lower visual importance than frames that do not have such motion. Content with high motion often is less perceptible to viewers than content that is still. Accordingly, content with high motion typically may be assigned lower priority.
Coding Type: Coded frames that were coded by intra coding may be assigned a relatively high visual importance as compared to frames that were coded by inter-coding techniques. Thus, a frame that was coded as an instantaneous decoder refresh frame (commonly, an “IDR” frame) is likely to serve as a prediction reference for a relatively large number of successive frames and may be assigned a high visual importance rating.
User Interactivity: Frames can be identified as visually important through user interactivity. For example, frames that contain information entered via a human operator (e.g., annotations to video, interactivity with user interface elements represented in the video, etc.) may be assigned a high visual importance rating.
Indications from Video Authoring Components: Modern user interfaces often apply animations rendered by general purpose processors or graphic processors. Therefore the user interfaces or applications that author video may provide indications identifying visual importance of the frames that they generate.

In still other embodiments, the estimation of box 330 may be performed after new frames are coded according to target bit rates that are defined by the new bandwidth conditions. If the frames coded under the new bandwidth conditions have a size (e.g., coded bit rate) lower than the frames coded under the prior bandwidth conditions, then the frames coded under the new bandwidth conditions may be estimated as having greater visual significance.

Moreover, video coders often include processes to spatially resize video as needed to conform their coding to new coding rates. In such an embodiment, frame size may be used as a basis to estimate relative visual significance of frames under a prior target bit rate that await transmission and the frames that are coded under the new target bit rate. If the frames coded under the new bandwidth conditions have a spatial size lower than the frames coded under the prior bandwidth conditions, then the frames coded under the new bandwidth conditions may be estimated as having greater visual significance.

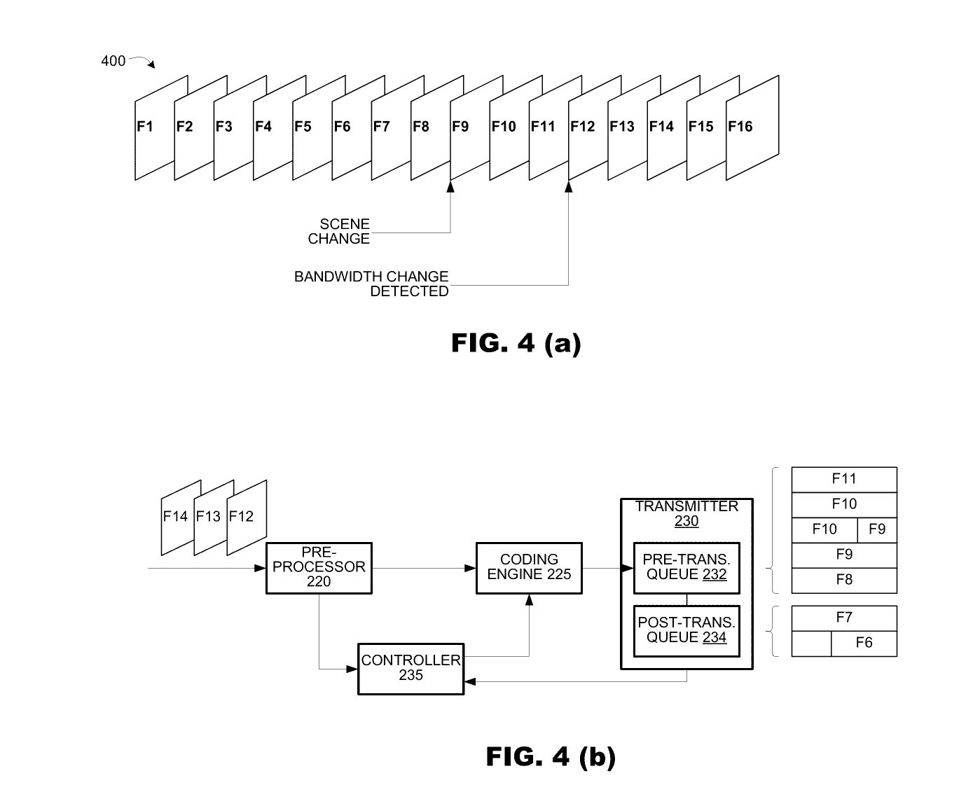

FIGS. 4(a) and 4(b) illustrate an exemplary video sequence 400 upon which the method may operate. In the example of FIG. 4(a), the video sequence includes frames F1-F16. A bandwidth change may be detected at a point where frames F1-F11 have been coded but frames F12-F16 await coding. In the example of FIG. 4(b), coded frames F6-F11 are in queue at the transmitter 230.

FIG. 4(a) indicates that a scene change occurs at frame F9. The scene change may be detected by a preprocessor 220 within the terminal. Thus, when estimating visual significance of the frames F6-F11 in queue and the frames F12-F14 yet to be coded, the method 300 may identify the frames F6-F8 as having less visual significance than the frames F9-F14. In this circumstance, an encoder may choose to discard F9-F11 and start coding F12 at the reduced bit-rate. The frame F12 is likely to be similar to F9, and it can be used to represent the new scene change point at the receiver side.

FIG. 4(b) illustrates a transmitter 230 that has two types of transmission queues: a pre-transmission queue 232 and a post-transmission queue 234. The pre-transmission queue 232 may store coded frames that are awaiting transmission to a communication network (not shown). The post-transmission queue 234 may store coded frames that have been transmitted to the communication network at least once but are retained in queue to satisfy the network's requirements for retransmission in the event of communication errors. For example, TCP networks require communication packets to be retained for possible retransmission until a transmitter 230 (FIG. 2) receives a message from a recipient that a transmitted packet was received successfully. If a packet is not confirmed to be received successfully, the transmitter 230 may have to retransmit the un-acknowledged packet.

In an embodiment of the present disclosure, when coded frames awaiting transmission are assigned lower priority, frames may be removed from the pre-transmission queue 232 prior to transmission to meet a new bandwidth estimate. For example, if a bandwidth estimate is revised to a level 0.5 MB/s than a prior estimate, then the method 300 may attempt to remove a number of coded frames from the pre-transmission queue 232 in an effort to reduce its data rate by the 0.5 MB/s.

The method 300 may evict coded frames from the queue according to any number of control techniques. They may include:
Identifying and deleting frames that were coded as non-reference frames. Reference frames are frames that were designated by an encoder as candidates to serve as prediction references for other frames that are to be coded by motion compensation prediction techniques. Non-reference frames may be given preferential treatment for eviction from the transmitter's queues over reference frames.
Identifying and deleting frames in an effort to preserve uniform display rates. For example, if one out of every two coded frames is to be deleted from the transmitter's queue, the method 300 may preserve frames to retain equal spacing between them. In the example illustrated in FIG. 4(b), where a transmitter's queues 232, 234 store frames F6-F11, the method may retain frames F7, F9 and F11.
Identifying frames within the queues 232, 234 that have relatively higher visual significance than other frames in the queues. The techniques described above in ¶ [30] also may be applied to identify frames that are to be preserved in favor of other frames that can be evicted from the queue. For example, frame F9 is shown as a scene change frame, which may be preserved in favor of frame F8, which precedes the scene change.
When frames are coded using scalability, coded enhancement layer data may be discarded but coded base layer data may be retained.

Embodiments of the present disclosure also permit frames to be evicted from the post-transmission queue 234 notwithstanding network protocol requirements that they be preserved for possible retransmission. In such an embodiment, when frames in queue are assigned a lower priority than frames that have yet to be coded, the method 300 simply may clear content of a post-transmission queue 234 (e.g., eviction of frames F6-F7). In this event, any transmission of coded frames that are successfully received by a receiving terminal (not shown) may be decoded and used by that terminal. Any transmission of coded frames that are not successfully received by the receiving terminal, however, will not be retransmitted because they will not available in the post-transmission queue 234. It is expected that the eviction of data from the post-transmission queue 234 may reduce loading of the communication network because the frames stored in the post-transmission queue 234 will have been coded according to a stale target bit rate level and, therefore, they will be coded for a higher bit rate than the communication network likely can accommodate. If these high bitrate frames are retransmitted through a network that has incurred a loss of resources, it likely will delay the network's ability to recover from the resource loss event.

Eviction of frames from a transmitter queue 232, 234 may occur for packets that represent only a portion of a frame. If for example, a frame had been partially transmitted at the time the method 300 is executed, then the method 300 may evict packets of the frame that remain in queue. Thus, in such an embodiment, a transmitter 230 may discontinue transmission of a partially-transmitted frame.

In a further embodiment, the method 300 may alter content of packets in the post-transmission queue 234 to remove their payload. In such an embodiment, the packets themselves would have reduced content, and, if retransmitted, may reduce loading of the network 130 (FIG. 1). Removal of packet payloads, however, likely will cause a receiver to discard them as having a transmission error because the revised payloads (which may be set to a null state or equivalent) may not agree with other parameters of the packets, such as packet length descriptors or CRC fields, that define payload content or length. Thus, such altered packets likely will not be used by a decoder if/when they are retransmitted.

When the frames F6-F11 in the transmission queues 232, 234 are identified as having higher priority than frames F12-F14 yet to be coded, the method 300 may alter resources that are to be assigned to the frames F12-F14 yet to be coded. Such alteration of resources may include:
Altering Coding Mode Assignments: Frames may be coded according to coding modes that lead to lower coding rates even if such coding modes violate default coding policies within an encoder. For example, many coders operate according to a coding policy that requires an input frame to be coded as an I frame at least once with in a predetermined number of frames (for example, once every 30 frames). When altering resources, an encoder may apply low data rate inter-coding modes to input frames, such as SKIP coding or direct mode prediction. In this manner, the encoder may lower bandwidth required to support coding of new input frames.
Altering Coding Parameters: Frames may be coded with coding parameters that limit the bit rates of coded to levels lower than are required to support the new bandwidth level. For example, quantization parameters may be set to a level sufficient to reduce bandwidth of the input frames yet to be coded to a level that accommodates transmission of the frames in queue.
Resizing Frames: Frames may be spatially downsampled and coded. As discussed above, downsampling may reduce the amount of image content to be coded by the coding engine.
Temporal Reduction: The frame rate of the video sequence yet to be coded may be reduced. Selection of frames to be eliminated from the video sequence may be made not only based on the new target bit-rate, but also based on the visual smoothness of decoded video sequence on the receiver side. Thus, an encoder may identify frames that may maintain a continuity between the already-coded frames in queue and the frames yet to be coded.
Reduction of a Number of Enhancement Layers: For scalable video coding, an encoder may reduce the number of enhancement layers used to code new portions of the video sequence.
   When the frames F6-F11 in the transmission queues 232, 234 are identified as having higher priority than frames F12-F14 yet to be coded, alteration of resources may be performed to lower a data rate of the new input frames F12-F14 once coded to a level that permits transmission of the frames in queue F6-F11. Prior to detection of the bandwidth change, the frames F6-F11 will have been coded with an expectation that a first level of bandwidth (BW1) was available for transmission of the coded frames F6-F11 through the network. The method 300 may be invoked when it is detected that the actual bandwidth of the network is at some lower level (BW2). When the method 300 determines that the transmission of the coded frames in queue F6-F11 are to be prioritized, then the method 300 may code the new input frames F12-F14 at a third bandwidth level (BW3) so that the BW1 and BW3 transmission requirements average out to the BW2 over some transmission time window. Once the time window expires, at which time the network should have processed transmission of the coded frames F6-F11, the method 300 may conclude and subsequent input frames (not shown in FIGS. 4(a) and 4(b)) may be coded at the bandwidth level BW2.

The foregoing discussion has described operation of the embodiments of the present disclosure in the context of coders and decoders. Commonly, video coders are provided as electronic devices. They can be embodied in integrated circuits, such as application specific integrated circuits, field programmable gate arrays and/or digital signal processors. Alternatively, they can be embodied in computer programs that execute on personal computers, notebook or tablet computers or computer servers. Similarly, decoders can be embodied in integrated circuits, such as application specific integrated circuits, field programmable gate arrays and/or digital signal processors, or they can be embodied in computer programs that execute on personal computers, notebook computers or computer servers. Decoders commonly are packaged in consumer electronic devices, such as gaming systems, smartphones, DVD players, portable media players and the like, and they also can be packaged in consumer software applications such as video games, browser-based media players and the like.

Several embodiments of the disclosure are specifically illustrated and/or described herein.

However, it will be appreciated that modifications and variations of the disclosure are covered by the above teachings and within the purview of the appended claims without departing from the spirit and intended scope of the disclosure.

1. A method, comprising:
responsive to a change in bandwidth available for transmission of coded video data;
estimating a visual significance of coded video data that has not yet been transmitted
and a visual significance of video data that is next to be coded,
comparing the estimated visual significance of the coded video data that has not yet been transmitted to the estimated visual significance of the video data that is next to be coded,
when the estimated visual significance of the coded video data that has not yet been transmitted is greater than the estimated visual significance of the video data that is next to be coded, prioritizing transmission of the coded video data that has not yet been transmitted over coding of the video data that is next to be coded, and
otherwise, prioritizing coding of the video data that is next to be coded over transmission of the coded video data that has not yet been transmitted.

2. The method of claim 1, wherein the estimation comprises:
performing scene change detection on the video data that is next to be coded and the coded video that has not yet been transmitted, and
assigning a higher visual significance rating to frames that follow a detected scene change than to frames that precede the detected scene change.

3. The method of claim 1, wherein the estimation comprises:
performing object detection respectively on the video data that is next to be coded and the coded video that has not yet been transmitted, and
assigning a higher visual significance rating to frames that include a detected object than to frames that do not include the detected object.

4. The method of claim 1, wherein the estimation comprises:
performing motion analysis respectively on the video data that is next to be coded and the coded video that has not yet been transmitted, and
assigning a higher visual significance rating to frames that include a relatively high motion content than to frames that include relatively low motion content.

5. The method of claim 1, wherein the estimation comprises:
detecting coding types assigned to the coded frames that have not yet been transmitted, and
assigning a higher visual significance rating to frames that are coded by intra-coding than to frames that are coded by inter-coding.

6. The method of claim 1, wherein, when transmission of the coded video data that has not yet been transmitted is prioritized over coding of the video data that is next to be coded, the method comprises decimating frames from the video data that is next to be coded.

7. The method of claim 1, wherein, when transmission of the coded video data that has not yet been transmitted is prioritized over coding of the video data that is next to be coded, the method comprises spatially downsizing frames from the video data that is next to be coded.

8. The method of claim 1, wherein, when coding of the video data that is next to be coded is prioritized over transmission of the coded video data that has not yet been transmitted, the method comprises evicting coded frames from a queue of a transmitter.

9. The method of claim 1, wherein, when coding of the video data that is next to be coded is prioritized over transmission of the coded video data that has not yet been transmitted, the method comprises clearing coded frames from a post-transmission queue of a transmitter.

10. A coding system, comprising:
a video coder to code an input video sequence,
a transmitter to transmit a coded video sequence to a network the transmitter including a transmission queue,
a controller to:
estimate bandwidth of the network,
responsive to a change in bandwidth available for transmission of coded video data, estimate a visual significance of coded video data in the transmission queue and
a visual significance of video data that is next to be coded by the video coder,
compare the estimated visual significance of the coded video data that has not yet been transmitted to the estimated visual significance of the video data that is next to be coded,
when the estimated visual significance of the coded video data that has not yet been transmitted is greater than the estimated visual significance of the video data that is next to be coded, prioritize transmission of the coded video data that has not yet been transmitted over coding of the video data that is next to be coded, and
otherwise, prioritize coding of the video data that is next to be coded over transmission of the coded video data that has not yet been transmitted.

11. The system of claim 10, wherein the estimation comprises:
performing scene change detection on the video data that is next to be coded and the coded video that has not yet been transmitted, and
assigning a higher visual significance rating to frames that follow a detected scene change than to frames that precede the detected scene change.

12. The system of claim 10, wherein the estimation comprises:
performing object detection respectively on the video data that is next to be coded and the coded video that has not yet been transmitted, and
assigning a higher visual significance rating to frames that include a detected object than to frames that do not include the detected object.

13. The system of claim 10, wherein the estimation comprises:
performing motion analysis respectively on the video data that is next to be coded and the coded video that has not yet been transmitted, and
assigning a higher visual significance rating to frames that include a relatively high motion content than to frames that include relatively low motion content.

14. The system of claim 10, wherein the estimation comprises:
detecting coding types assigned to the coded frames that have not yet been transmitted, and
assigning a higher visual significance rating to frames that are coded by intra-coding than to frames that are coded by inter-coding.

15. The system of claim 10, wherein, when transmission of the coded video data that has not yet been transmitted is prioritized over coding of the video data that is next to be coded, the instructions cause the processing device to decimate frames from the video data that is next to be coded.

16. The system of claim 10, wherein, when transmission of the coded video data that has not yet been transmitted is prioritized over coding of the video data that is next to be coded, the instructions cause the processing device to spatially downsize frames from the video data that is next to be coded.

17. The system of claim 10, wherein, when coding of the video data that is next to be coded is prioritized over transmission of the coded video data that has not yet been transmitted, the instructions cause the processing device to evict coded frames from a queue of a transmitter.

18. The system of claim 10, wherein, when coding of the video data that is next to be coded is prioritized over transmission of the coded video data that has not yet been transmitted, the instructions cause the processing device to clear coded frames from a post-transmission queue of a transmitter.

19. A computer readable medium storing program instructions that, when executed by a processing device, causes the processing device to:
responsive to a change in bandwidth available for transmission of coded video data, estimate a visual significance of coded video data that has not yet been transmitted and
a visual significance of video data that is next to be coded,
compare the estimated visual significance of the coded video data that has not yet been transmitted to the estimated visual significance of the video data that is next to be coded,
when the estimated visual significance of the coded video data that has not yet been transmitted is greater than the estimated visual significance of the video data that is next to be coded, prioritize transmission of the coded video data that has not yet been transmitted over coding of the video data that is next to be coded, and
otherwise, prioritize coding of the video data that is next to be coded over transmission of the coded video data that has not yet been transmitted.

20. The medium of claim 19, wherein the estimation comprises:
performing scene change detection on the video data that is next to be coded and the coded video that has not yet been transmitted, and
assigning a higher visual significance rating to frames that follow a detected scene change than to frames that precede the detected scene change.

21. The medium of claim 19, wherein the estimation comprises:
performing object detection respectively on the video data that is next to be coded and the coded video that has not yet been transmitted, and
assigning a higher visual significance rating to frames that include a detected object than to frames that do not include the detected object.

22. The medium of claim 19, wherein the estimation comprises:
performing motion analysis respectively on the video data that is next to be coded and the coded video that has not yet been transmitted, and
assigning a higher visual significance rating to frames that include a relatively high motion content than to frames that include relatively low motion content.

23. The medium of claim 19, wherein the estimation comprises:
detecting coding types assigned to the coded frames that have not yet been transmitted, and
assigning a higher visual significance rating to frames that are coded by intra-coding than to frames that are coded by inter-coding.

24. The medium of claim 19, wherein, when transmission of the coded video data that has not yet been transmitted is prioritized over coding of the video data that is next to be coded, the instructions cause the processing device to decimate frames from the video data that is next to be coded.

25. The medium of claim 19, wherein, when transmission of the coded video data that has not yet been transmitted is prioritized over coding of the video data that is next to be coded, the instructions cause the processing device to spatially downsize frames from the video data that is next to be coded.

26. The medium of claim 19, wherein, when coding of the video data that is next to be coded is prioritized over transmission of the coded video data that has not yet been transmitted, the instructions cause the processing device to evict coded frames from a queue of a transmitter.

27. The medium of claim 19, wherein, when coding of the video data that is next to be coded is prioritized over transmission of the coded video data that has not yet been transmitted, the instructions cause the processing device to clear coded frames from a post-transmission queue of a transmitter.
